(19) United States
(12) Patent Application Publication
(10) Pub. No.: US 2008/0102816 A1
(43) Pub. Date: May 1, 2008

(54) AUTOMATIC DEVICE DETECTION SYSTEM AND METHOD

(75) Inventors: Mingjun Shan, Shenzhen (CN); Xiaoyi Dong, Shenzhen (CN); Kepeng Li, Shenzhen (CN); Hai Shen, Shenzhen (CN); Qi Shu, Shenzhen (CN); Xiaoqian Chai, Shenzhen (CN); Jiangshui He, Shenzhen (CN); Hongtao Zhou, Shenzhen (CN); Peng Cui, Shenzhen (CN); Linyi Tan, Shenzhen (CN)

Correspondence Address: LADAS & PARRY, 5670 WILSHIRE BOULEVARD, SUITE 2100, LOS ANGELES, CA, 90036-5679, US

(73) Assignee: HUAWEI TECHNOLOGIES CO., LTD., Shenzhen (CN)

(21) Appl. No.: 11/969,767

(22) Filed: Jan. 4, 2008

(30) Foreign Application Priority Data
Sep. 14, 2006 (CN) PCT/CN2006/002391
Sep. 16, 2005 (CN) 200510103307.5
Mar. 13, 2006 (CN) 200610057407.3

(51) Int. Cl. H04Q 7/20

(52) U.S. Cl. 455/424

(57) ABSTRACT

A system and method for automatically detecting the device in the network communication field. A terminal identity-acquiring module in a device management server receives the terminal information reported by the terminal, acquires the entire terminal identity information based on the terminal information, updates the associate terminal information currently stored based on the identity information, actively maintains the configure information of the mobile terminal. The present invention realizes automatically acquiring the terminal identity information, improves the quality of service of the ISP, reduces the manual manipulation and gives facilities for the user.

### FIELD OF THE INVENTION

The present invention relates to the field of network communications, and in particular to an automatic device detection system and method.

### BACKGROUND OF THE INVENTION

A mobile terminal, which is an important component in the entire mobile operation service system, includes mobile devices such as mobile phone terminals, palmtops, portable computers, embedded devices, vehicle system, and etc. As the function of terminals becomes more and more complicated, more and more problems will occur in terminal software. How to assure user's experience effectively, improve user's faithfulness, and maintain high efficiency service quality and low cost of device maintenance becomes an important attention point for operator and terminal vendor. The object of Open Mobile Alignment Device Management (OMADM) specification lies in this point.

The conventional Device Management (DM) specification is a sort of technique for managing, diagnosing and maintaining mobile terminal devices. In the conventional DM specification, a terminal reports a message or informs the DM server to manage the terminal in the following several manners: registering at a sales outlet, registering on a Web site, registering through a voice prompt system, and registering when connecting to the mobile network at the first time, etc.

Since the mobile terminal needs to be used with a smart card, when a new card is inserted into the terminal or the card is replaced, it needs to report information, such as the type of the terminal, International Mobile Equipment Identity (IMEI), International Mobile Subscriber Identity (IMSI), Mobile Station ISDN (MSISDN) etc, to the DM server and inform the DM server to manage the mobile terminal.

In the conventional specification, the acquisition of the terminal information is not achieved automatically but needs the user's participation. That is relatively complex.

### SUMMARY OF THE INVENTION

The present invention provides an automatic device detection system and method, in which, a terminal reports terminal identification information automatically, and a Device Management server (DMS) gets the terminal information according to change event information of the terminal or in real time.

The technical solutions of the present invention are as follows.

According to an embodiment of the invention, an automatic device detection system includes a device management service component, a lower layer network element component and a peripheral component, wherein the device management service component includes a terminal identification acquisition module for receiving terminal information and obtaining complete terminal identification information of the terminal according to the terminal information, and updating relative terminal information stored currently according to the complete terminal identification information.

The device management service component further includes:

a Device Management Server (DMS) for receiving terminal information or terminal change event information reported by the lower layer network element component and monitoring and managing the subscriber terminal; and/or,

a Terminal Information Center (TIC) for storing terminal information, monitoring change of terminal information, reporting terminal information or terminal information change event to DMS and processing a query request from the DMS; and/or,

a Short Message Front End Processor for receiving a short message from a mobile terminal, obtaining terminal information through the short message and report it to the DMS; and/or,

a Network Detect Proxy (NDP) device for obtaining terminal information from the lower layer network element component.

The terminal identification acquisition module is configured in the DMS.

The TIC, the DMS or the NDP is further used for informing all watchers subscribing to user presence information about newest user presence information.

An automatic device detection method, includes:

A. a terminal reports terminal information automatically to a management side;

B. the management side obtains complete terminal identification information according to the received terminal information and updates relevant terminal information stored presently.

The information reported by the terminal includes:

International Mobile Subscriber Identity (IMSI), International Mobile Equipment Identity (IMEI), Mobile Station ISDN (MSISDN) information and the combination relationship information thereof.

Step A includes:

A1. a terminal reports terminal information to management side through automatically sending a short message.

In the mobile terminal, the short message is sent by a smart card, the smart card carrying therein address information of the DMS of the management side.

In the mobile terminal, the short message is sent by a device management agent of the mobile terminal supporting the function of device management, and the device management agent contains the DMS address information of the management side.

Step A further includes:

A2. collecting terminal information using an NDP: the management side obtains the terminal information by querying the NDP in real time so as to obtain complete terminal identification information.

Step A2 further includes:

A21. the terminal establishes a connection with a corresponding network, and a lower layer network element component obtains combination information of IMEI and IMSI through authenticating identity of the terminal;

A22. the lower layer network element component obtains IMSI, IMEI and combination relationship information of IMSI, IMEI and MSISDN according to the combination information, and requests NDP for checking;

A23. NDP stores the information, and reports it to TIC, then the TIC judges whether the combination information has been changed, if so, informs the DMS;

A24. when receiving the device update event information of the TIC, the DMS requests to obtain the updated terminal information from the TIC; or the DMS obtains the updated terminal information initiatively through querying the TIC in real time.

The information stored by the NDP and reported to the TIC includes: IMEI, IMSI, MSISDN, Location Area Identification code (LAI) and location information.

Step A further includes:

A3. the DMS of the management side sends a monitoring task, and the terminal reports terminal information according to the monitoring task.

The monitoring task sent by the DMS is a monitoring task table, for predetermining the information needed to be reported by terminal.

The monitoring task table contains a monitoring item for monitoring a terminal event or change.

Step A3 further includes:

the monitoring task obtains terminal identification information in a query manner and reports it to the DMS.

Step A3 further includes:

the monitoring task obtains terminal identification information in an interruption manner and reports it to the DMS.

It can be seen from the above technique solution provided by the present invention that the DMS detecting terminal identification information automatically and updating in time the relative terminal information stored presently is implemented according to the present invention which advances the service quality of operator, makes user convenient and simplifies user's operation.

### BRIEF DESCRIPTION OF THE DRAWINGS

FIG. 1 is a schematic diagram illustrating the system architecture according to the present invention;

FIG. 2 is a flow chart illustrating the operation of the method according to the first embodiment of the present invention;

FIG. 3 is a flow chart illustrating the operation of the method according to the second embodiment of the present invention;

FIG. 4 is a schematic diagram illustrating an IMEI structure;

FIG. 5 is flow chart illustrating the operation of the method according to the third embodiment of the present invention.

### DETAILED DESCRIPTION OF THE EMBODIMENTS

The present invention provides an automatic device detection system and method. A Device Management Server (DMS) obtains information of a mobile terminal automatically, then obtains complete terminal identification information according to the terminal information, and updates in time relevant information of the mobile terminal stored currently, thus maintaining configuration information of the mobile terminal initiatively.

The present invention provides an automatic device detection system. The architecture of the system is shown in FIG. 1. The abbreviations in FIG. 1 are interpreted as follows:

| Abbreviations | English full name |
|---|---|
| BOSS | Business and Operation Support System |
| IVR | Interactive Voice Response |
| SGSN | Serving GPRS Support Node |
| GGSN | Gateway GPRS Support Node |
| SMSC | Short Message Service Center |
| MSC | Mobile Switching Center |
| HLR | Home Location Register |
| WAP GW | WAP Gateway |
| SMPP | Short Message Peer to Peer |
| TIC | Terminal Information Center |
| NDP | Network Detect Proxy |
| CAE | Content Adaptation Engine |

Each interface is interpreted as follows:

| Interface Name | Function Description | | Protocol Description |
|---|---|---|---|
| TM interface | 1. | TIC−>DMS: notifies change of | CORBA or SOAP |
| | | combination of IMEI and MSISDN, at | protocol, the CORBA |
| | | least including IMEI, MSISDN and | is suggested. |
| | | terminal capacity information; | |
| | 2. | DMS−>TIC: subscribes to the above | |
| | | combination change event. | |
| TC interface | SGSN/MSC−>TIC: | | TCP |
| | reports IMEI and MSISDN/IMSI | | |
| | combination relationship. | | |
| TT interface | TIC−>CEIR: queries interface in real time | | HTTP |
| | based on HTTP protocol; or downloads | | |
| | from IMEI database. | | |
| MP interface | DMS<−>Portal, DMS<−>customer service | | CORBA or SOAP |
| | center/business lobby: | | |
| | 1) | configuration download; | |
| | 2) | configuration | |
| | | parameters maintenance; | |
| | 3) | batch configuration. | |

| | | |
|---|---|---|
| TP interface | Portal−>TIC: maintenance and | CORBA or SOAP |
| | management of terminal capacity | |
| | information | |
| MB interface | BOSS/MDSP−>DMS: | FTP/HTTP |
| | subscriber service subscription | |
| | management synchronization | |

According to FIG. 1, DMS, TIC, SMS FEP and NDP are DM service components, the function of which relates to automatic detection implementation. The DMS is a device management server for obtaining terminal information of lower layer network element components or terminal change event information, monitoring and managing user's terminal. The DMS is a main function component for implementing DM service, and can provide terminal devices with functions such as parameter configuration, software download, firmware update and fault diagnosis, etc. A terminal identification acquisition module (not shown in the Figures) is included in the DMS for receiving terminal information and obtaining entire identification information of the terminal automatically according to the terminal information, and then updating relative information stored currently based on the identification information.

The TIC is a terminal device information center for storing terminal information, monitoring change of terminal information, reporting terminal information or terminal change event information to the DMS and processing query request from the DMS.

The NDP is a network detect proxy device for obtaining terminal information from lower layer network element components and reporting the terminal information to the TIC, or directly reporting to all watchers subscribing to user presence information.

The SMS FEP is a short message service front end processor for receiving short messages from mobile terminals, and acquiring terminal information through short messages and reporting the terminal information to the DMS.

The TM interface therein is used for intercommunication between the DMS and the TIC. Once the combination of IMEI and MSISDN of a terminal device changes, the TIC will report the new combination relationship to the DMS via the interface, or the DMS may subscribe to the foregoing combination change event and query the TIC about the foregoing combination change event in real time via the interface.

The TT interface therein is used for information exchange between the TIC and the NDP. The TIC queries the NDP about terminal identification information in real time via the interface.

In FIG. 1, WAP GW/GGSN, SMSC and SGSN/MSC/HLR, which are connected with the DM service components, are lower layer network element components and mainly used for device detection. The WAP GW is connected to the DMS, and is used for sending WAP message to terminals, processing WAP connection messages sent from terminals. The SMSC is used for distributing short messages to terminals, receiving short messages transmitted from terminals and forwarding the messages to the DM service components. The GGSN, which may be connected with different data networks, mainly serves as a gateway, and performs protocol conversion for General Packet Radio Service (GPRS) packet data. The SGSN is a node that provides services for mobile terminals. The MSC takes charge of one or more base station subsystems, and accomplishes mobility management and service of terminals and interchanges with PSTN. The HLR records subscriber information registered locally. These lower layer components belong to general function components, which can communicate with terminal devices via 2G/2.5G/3G access network.

In FIG. 1, the function components connected with the upper half part of the dashed frame are peripheral components interrelated with the DM service, wherein the BOSS is responsible for charging and deducting fund, and DMS transmits the call detail record (CDR) bill to the BOSS. The Customer Service Center and the Interactive Voice Response (IVR) system are responsible for processing service requests made by users and the request can be made by placing a call or transacting in a business lobby, etc. The U-Portal is a user portal, and the user can submit device management service request through Web site or WAP site. The foregoing components, which intercommunicate with the DMS, are used for processing service requests and charging for the processed services. Other components in FIG. 1 can intercommunicate with the TIC, wherein, the CAE is a content adaptation engine which can perform content adaptation according to terminal capacity. The Presence server is used for checking whether a terminal is online. The GUP Server is a general user information server for storing general user information.

The present invention further provides an automatic device detection method, and the method of the invention will be described by way of three embodiments as follows.

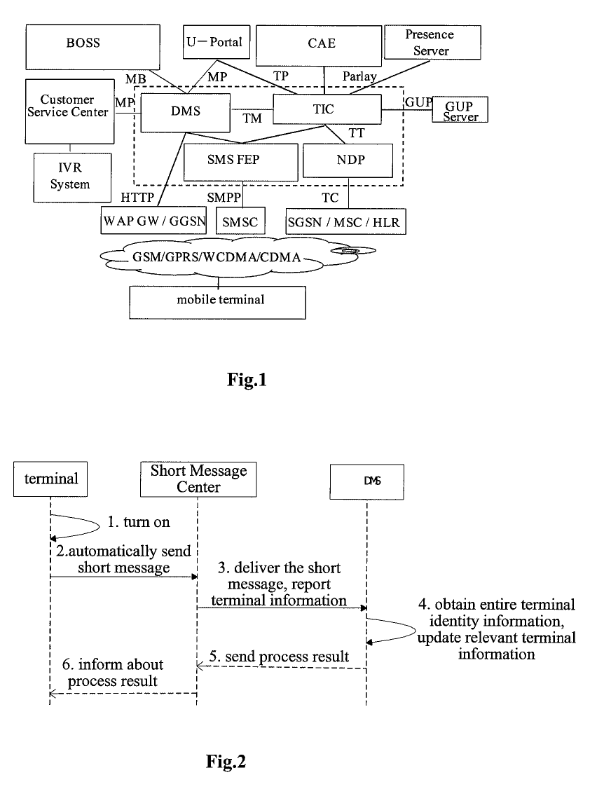

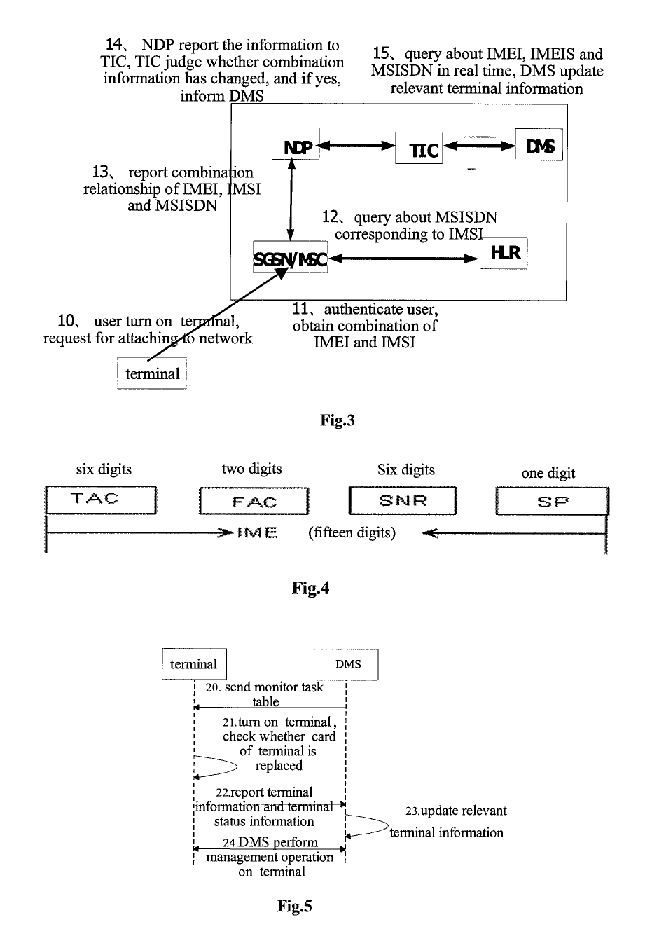

According to the first embodiment of the invention, a method is provided in which the mobile terminal transmits a short message automatically, as in FIG. 2. The method includes:

Step 1: the user inserts a new card or replaces a card and turns on the terminal;

Step 2: the terminal transmits a short message automatically, reporting terminal information;

When a card is inserted or replaced and the terminal is turned on for the first time, the terminal transmits a short message automatically to the short message center firstly, thereby reporting the terminal information which includes IMEI and IMSI etc. It may be that an intelligent card carrying DMS address transmits a short message to the DMS automatically after the terminal has been turned on; or it may also be that a Device Management Agent (DM Agent) carrying DMS address information sends a short message to the DMS automatically after the terminal has been turned on. The DM Agent is a service component of the terminal which supports Device Management (DM) function, and is responsible for intercommunicating with the DMS, explaining and executing commands sent by the DMS;

Step 3: a short message center delivers the short message and reports the terminal information to the DMS;

After receiving the short message sent by the terminal, the short message center forwards the short message and reports it to the DMS;

Step 4: the DMS receives the short message, obtains entire terminal identification information, and updates relevant terminal information stored currently;

A terminal identification acquisition module in the DMS, based on the terminal information contained in the received short message, searches other information about the mobile terminal in other network element devices and obtains the entire terminal identification information, and updates relevant terminal information stored currently. The entire terminal identification information includes: terminal type, software version, IMEI, IMSI, MSISDN and combination relationship thereof, etc. The updating process includes adding, modifying or cancelling the terminal identification information stored in the DMS;

Step 5: the DMS sends a process result to the short message center;

After the foregoing process has been completed, the process result will be sent to the short message center, i.e., an update response message will be sent to the short message center;

Step 6: the short message center informs the terminal of the forgoing process result.

According to the second embodiment of the invention, a method is provided in which an NDP collects terminal information and stores it in TIC, as shown in FIG. 2. The method includes:

Step 10: when a new card is inserted into a terminal or the card of the terminal is changed, and the terminal is turned on, a request for attaching network is sent,

Each time a new card is inserted into a terminal or the card of the terminal is replaced and the terminal is turned on, it is needed for the terminal to search a network corresponding to the card and establish a connection with the network.

Step 11: in the process of attaching, SGSN/MSC will start a process for checking IMEI. SGSN/MSC sends an identity verification request to the user terminal and obtains the IMEI and IMSI combination information of the terminal from an identity verification response returned by the user terminal.

Step 12: SGSN/MSC queries HLR about MSISDN corresponding to the terminal's IMSI according to the obtained IMEI and IMSI combination information, and stores the correspondence relationship between IMSI and IMEI/MSISDN.

Step 13: when obtaining the IMEI, IMSI and the combination relationship information with the MSISDN, the SGSN/MSC sends a check request message Check-IMEI to the NDP. The check request message contains: IMEI, IMSI, MSISDN, LAI and location information, etc.

The IMEI is an International Mobile Equipment Identification, and is stored in the terminal. The IMEI uniquely corresponds to a terminal and is used for identifying the number of a mobile equipment. The structure of the IMEI is shown in FIG. 4, in which TAC is a Type Approval Code, distributed by the Europe Type Approval Center; FAC is a Final Assembly Code which is coded by the vendor, indicating a vendor or a place where the final assembly is performed; SNR is a Serial Number Code and this numerical independent serial number code uniquely identifies each mobile equipment of each TAC and FAC; SP is a reserved bit.

The IMSI is an International Mobile Subscriber Identification, and is stored in a SIM card. The IMSI is used for uniquely identifying a user in the GSM/PLMN network and uniquely indicating the user identity.

The MSISDN, which is a number being dialed from the PSTN or ISDN to GSM system, is presently the number of a mobile phone and has correspondence relationship with IMSI. IMSI is used for identifying subscribers and MSISDN is used for identifying basic services. For example, the MSISDN number used for calling is different from the MSISDN number used for sending fax, that is to say, a subscriber may have a plurality of MSISDN numbers.

The LAI is a location area identification code, which is used for updating the location of a mobile subscriber.

The location information is detailed information about the current location of the subscriber.

Wherein IMEI, IMSI and MSISDN can be regarded as the combined relationship information and from the information it can be identified whether the user replaces a SIM card or a mobile phone.

NDP obtains terminal information when it intercepts a verification request message sent by SGSN/MSC, and stores the terminal information;

Step 14: NDP reports the information to TIC, which judges whether the combination information is changed, and informs DMS if it changes;

Or don't inform the DMS if it doesn't change;

Step 15: when receiving information on device information update event of the TIC, the DMS requests the TIC for the updated terminal information; or the DMS queries the TIC in real time and obtains the updated terminal information initiatively, and updates the terminal identification information according to the information;

Since the above terminal information is stored by TIC, the DMS can obtain the IMEI, or the combination information of IMEI and MSISDN only through querying TIC in real time, needless of the user's participation. Then a terminal identity acquisition module in the DMS searches other information related to the mobile terminal according to the terminal information, obtains the entire terminal identification information, and updates the relevant terminal information stored in the DMS currently.

Either one of TIC, DMS or NDP can inform a presence server about IMEI, IMSI, MSISDN, LAI, location information, etc., and can inform all watchers that subscribe to the user presence information about the newest presence information of the user.

According to the third embodiment of the invention, a method is provided in which the DMS sends a monitoring task, as shown in FIG. 5. This method is used in the situation of replacing a card, wherein the DMAcc (DMS accounts) information of the new card is identical with that of the old card and re-boot is needless. For example, the two cards are both M-zone cards of China Mobile. After the two cards have been exchanged, the DMS can also establish a session connection with the terminal based on the configuration information that is boot previously. The method includes the following step, in which the process of establishing a connection between the DMS and the terminal and returning a session message between the DMS and the terminal are the same as standard OMA DM specification.

Step 20: when the DMS is connected with the terminal, the DMS sends a monitoring task to the terminal;

As an example of the invention, a monitoring task table is sent. The monitoring task table includes a monitor item, which is used to check event or change of the terminal, e.g., whether replacing a card. A query mode may be adopted, the monitoring task table predetermines contents to be reported and when a card is replaced for a terminal, the predetermined content in the monitoring task table is reported; also an interruption mode may be adopted, once the event of replacing a card for a terminal happens, the terminal is triggered to report the terminal information. The invention is described by adopting query mode as example.

Step 21: when a user turns on a terminal, the monitoring task item checks whether the card of the terminal is replaced;

Step 22: if an event of replacing a terminal card is detected, the predetermined terminal information in the monitoring task table is reported;

The information required to be reported by a terminal is predetermined in a monitoring task table sent by DMS, including terminal information and terminal state information. The terminal information includes: IMEI, IMSI, MSISDN or the combination relationship information of them, etc.; the terminal state information includes: version number, whether a software update operation or a firmware update operation is required, and the subscriber downloads a record, etc.; the terminal state information can be recorded in the management object (MO) of the terminal;

Step 23: the DMS updates relevant terminal information stored currently according to the information reported by the terminal;

Step 24: DMS executes relevant management operation on the terminal;

The management operation includes: if the card is replaced under the condition of the terminal being theft or lost, such operations as data wiping, information destroy and terminal locking etc. are required to be performed. If the card of the terminal is replaced by the user initiatively, the operation of backup data restoration is performed, i.e., the data backup in the DM server before the card is replaced by the user is restored into the terminal. The DMS can perform the operations of firmware update and software update etc. according to the state information reported by the terminal.

To sum up, an automatic detection of terminal information can be achieved through three kinds of methods of the invention. The DMS obtains the entire terminal identification information automatically according to the terminal information, improving service quality of the operator and reducing the amount of the user operations, which is convenient for the user.

The above are only the preferred embodiments of the invention and the protection scope of the invention is not limited to this. Within the technique range disclosed according to the invention, various changes and displacements that can be easily find out by those skilled in the art should come within the scope of the appended claims and their equivalents.

1-17. (canceled)

18. An automatic device detection system, comprising a plurality of device management service components adapted to communicate with a terminal through a plurality of lower layer network element components, wherein the plurality of the device management service components include a device management server, the device management server being adapted to automatically obtain terminal information and obtain terminal identification information of the terminal according to the terminal information.

19. The automatic device detection system according to claim 1, wherein, the plurality of the device management service components further include:
a short message center, connected to the device management server and adapted for short message exchange between the terminal and the device management server;
and the short message center is further adapted to forward a short message including the terminal information to the device management server after receiving the short message from the terminal.

20. The automatic device detection system according to claim 1, wherein the plurality of the device management service components further include:
a network detection proxy connected to the lower layer network element components, adapted to collect terminal information through the lower layer network element components;
a terminal information center connected to the network detection proxy, adapted to receive terminal information, determine whether the terminal information is changed, and inform the device management server if the terminal information is changed.

21. The automatic device detection system according to claim 1, wherein the device management server further comprises:
a monitoring task table, adapted to predetermine contents to be reported by the terminal, the terminal automatically reporting the contents predetermined in the monitoring task table when a card of the terminal is replaced or a new card is inserted into the terminal and the terminal is turned on.

22. The automatic device detection system according to claim 1, wherein the terminal information comprises:
International Mobile Subscriber Identity (IMSI), International Mobile Equipment Identity (IMEI), Mobile Station ISDN (MSISDN information), and combination relationship information of the IMSI, the IMEI and the MSISDN information.

23. A automatic device detection method, used for automatically obtaining terminal information by a device management server, comprising:
receiving the terminal information; and
obtaining complete terminal identification information according to the received terminal information; and
updating currently stored relevant terminal information according to the complete terminal identification information.

24. The automatic device detection method according to claim 6, wherein the terminal information comprises:
International Mobile Subscriber Identity (IMSI), International Mobile Equipment Identity (IMEI), Mobile Station ISDN (MSISDN information), and any combination of the IMSI, the IMEI and the MSISDN information.

25. The automatic device detection method according to claim 6, wherein the step of receiving comprises:
sending a short message including terminal information to a short message center by the terminal;
reporting the terminal information to the device management server by the short message center.

26. The automatic device detection method according to claim 8, wherein, in the terminal, the short message is sent by a smart card, the smart card carrying therein address information of the device management server.

27. The automatic device detection method according to claim 8, wherein, in the terminal, the short message is sent by a device management agent supporting device management function in the terminal, the device management agent carrying address information of the device management server.

28. The automatic device detection method according to claim 6, wherein the step of receiving comprises:
collecting terminal information of the terminal by a network detection proxy through the lower layer network element components;
obtaining terminal identification information by the device management server in a real-time query manner according to the terminal information reported by the network detection proxy.

29. The automatic device detection method according to claim 11, wherein the step of obtaining comprises:
after receiving the terminal information reported by the network detection proxy a terminal information center determining if a card of the terminal is replaced or a new card is inserted into the terminal, if so, informing the device management server;
after receiving device information update event information from the terminal information center, the device management server querying the terminal information center for updated terminal information.

30. The automatic device detection method according to claim 6, wherein the step of receiving comprises:
establishing a connection with the lower layer network element components by the terminal, and the lower layer network element components obtaining combination information of IMEI and IMSI through authenticating identity of the terminal;
obtaining combination relationship information of IMSI, IMEI and MSISDN by the lower layer network element components according to the combination information, and requesting the network detection proxy for checking;
storing the information by the network detection proxy, and reporting it to the terminal information center, the terminal information center judging whether the combination information has been changed, if so, informing the device management server;
when receiving the device update event information from the terminal information center, the device management server requesting to obtain the updated terminal information from the terminal information center.

31. The automatic device detection method according to claim 6, wherein the step of receiving comprises
sending a monitoring task by the device management server to the terminal, and the terminal reporting terminal information according to the monitoring task.

32. The automatic device detection method according to claim 14, wherein the monitoring task sent by the device management server is a monitoring task table, used for predetermining information needed to be reported by the terminal.

33. The automatic device detection method according to claim 15, wherein the monitoring task table contains a monitor item for monitoring a terminal event or change.

34. The automatic device detection method according to claim 14, wherein the step of reporting comprises:
the monitoring task obtaining terminal identification information in a query manner and reporting it to the device management server.

35. The automatic device detection method according to claim 14, wherein the step of reporting comprises:
the monitoring task obtaining terminal identification information in an interruption manner and reporting it to the device management server.
